(19) United States
(12) Patent Application Publication
(10) Pub. No.: US 2004/0112817 A1
(43) Pub. Date: Jun. 17, 2004

(54) Magnetization device

(76) Inventor: Guo-Hua Zhang, Dalian (CN)

Correspondence Address: BROWN, RAYSMAN, MILLSTEIN, FELDER & STEINER LLP, 900 THIRD AVENUE, NEW YORK, NY, 10022, US

(21) Appl. No.: 10/276,412

(22) PCT Filed: May 8, 2001
(86) PCT No.: PCT/CN01/00683

(51) Int. Cl. B01D 35/06

(52) U.S. Cl. 210/222

(57) ABSTRACT

The invention discloses a magnetizing device of new structure, with external and internal baffles of diamagnetic materials installed between a pipe wall and a connecting shaft of magnetic conductivity materials, and continuous ring-shaped magnetic steels having the same pole name and magnetic collection rings arranged between the external and the internal baffles. The invention overcomes the disadvantages of large size, high energy consumption and expensive price existing in current water magnetizers. The magnetizing device has a simple structure and mass production thereof is simple, which device can be widely used in industrial and agricultural productions and food sanitation. It is capable of magnetizing petroleum, water and other liquids quickly.

### BACKGROUND OF THE INVENTION

The present invention relates to a type of magnetizing device, particularly to a device used to magnetize petroleum, water and other liquids.

### DESCRIPTION OF THE RELATED ART

People have been using water magnetizers for a long time. Although the water magnetizers of both electromagnetic and magneto types are the currently widespread, they have lots of shortcomings. For example, in addition to having a high energy consumption, the electromagnetic magnetizer usually has a large size and is costly; the application of magneto magnetizer is basically limited within the range of paramagnetic field, with certain but unremarkable effect.

### SUMMARY OF THE INVENTION

The purpose of the invention is to provide many users with a magnetizing device of a new structure making sufficient use of magnetic energy. It will overcome the disadvantages existing in current water magnetizers and will be applied to the applications in industrial and agricultural productions.

The implementation of the invention is as follows: layers of external and internal baffles of diamagnetic materials are installed between a pipe wall and a connecting shaft of magnetic conductivity materials. Between the external and internal baffles of diamagnetic material of each layer, continuous ring-shaped magnetic steel having the same pole and magnetic collection rings are stacked vertically. T

he continuous ring-shaped magnetic steel having the same pole in a lower layer is arranged such that the poles are opposite to those of the continuous ring-shaped magnetic steel having the same pole on the layer directly above, and the magnetic collection ring have a thickness and a diameter greater than that of the magnetic steel interposed therebetween.

As the magnetic collection rings, which have thickness and diameter greater than those of the magnetic steel, are added between two of the same poles, attraction takes place between them. Moreover, as the magnetic collection ring has a diameter greater than the magnetic steel, the magnetic lines of force of two of the same poles, which lines do not cross each other, are centralized in the magnetic collection rings to generate respective loops, resulting in alternate oscillation of high frequency occurring in the passing polar liquid molecules.

Moreover, as violent turbulence is formed due to linear velocity in the baffling direction changing area when liquid passes the continuous baffles with opposite angles, all of the physicochemical data is changed in the turbulent area by the influence of the two powerful magnetic lines of force in opposite directions at the magnetic collection ring.

### BRIEF DESCRIPTION OF THE DRAWINGS

FIG. 1 is a schematic view, in which 1 indicates the pipe wall of magnetic conductivity material, 2 indicates the external baffle of diamagnetic material, 3 indicates the magnetic collection ring, 4 indicates the magnetic steel, 5 indicates the internal baffle of diamagnetic material and 6 indicates the connecting shaft of magnetic conductive material.

FIG. 2 shows a cross-sectional view along line A-A of the example for implementation.

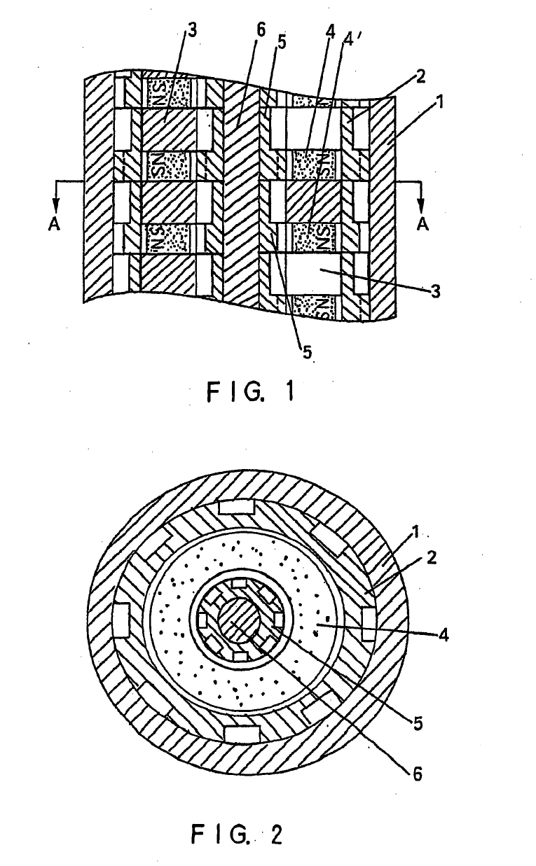

### DESCRIPTION OF THE PREFERRED EMBODIMENT

Now further description will be given to the invention in combination with the drawings. A connecting shaft 6 of magnetic conductive material is placed in the center of the pipe of magnetic conductive material. Layers of external baffles 2 and internal baffles 5 of diamagnetic material are installed between a pipe wall 1 and the connecting pipe 6 of diamagnetic material. Between the external baffles 2 and the internal baffles 5 of diamagnetic material on each layer, continuous ring-shaped magnetic steels 4, 4′ having the same pole are vertically stacked. The external baffle 2 and the internal baffle 5 of diamagnetic material, magnetic steels 4, 4′ and a magnetic collection ring 3 form one layer of assembly in the magnetic field, in which the thickness and diameter of the magnetic collection ring 3 are greater than those of the magnetic steels 4, 4′.

Depending on the magnetizing requirements, layers of assemblies in the magnetic field are stacked with each other and the adjacent continuous ring-shaped magnetic steels 4, 4′ having the same pole are placed with their poles opposite to each other and continuously connected. The continuous ring-shaped magnetic steels 4, 4′ having the same pole and the magnetic collection ring 3 are arranged alternately. As the magnetic collection ring 3 is greater than magnetic steel 4 in diameter, the magnetic lines of two of the same poles which lines do not cross each other are centralized in the magnetic collection ring 3 to generate respective loops, resulting in alternate oscillation of high frequency occurring in the passing polar liquid molecules.

Grooves are opened longitudinally in the external baffle 2 and the internal baffle 5 of diamagnetic material to allow liquid to flow therethrough. The external baffles 2 and the internal baffles 5 of diamagnetic material of adjacent layers are arranged in certain angles circumferentially to form the baffling device of diamagnetic material.

### POSSIBILITY OF INDUSTRIAL APPLICATION

Modified from current magnetizers, the invention has the advantage of being simple in structure, rational in design and easy for mass production. It is capable of magnetizing petroleum, water and other liquids quickly. The product will be widely used in industrial and agricultural productions and food sanitation.

1. A magnetizing device of new structure mainly comprising: a pipe wall of magnetic conductivity material, external baffles of diamagnetic material, a magnetic collection ring, a magnetic steel, internal baffles of diamagnetic material, a connecting shaft of magnetic conductive material wherein
layers of the external and the internal baffles of diamagnetic material are installed between the pipe wall and the connecting shaft of magnetic conductive material, between the external and the internal baffles of diamagnetic material on each layer, a continuous ring-shaped magnetic steel having the same pole and the magnetic collection rings are vertically stacked; the poles of the adjacent continuous magnetic steels 4, 4′ are arranged to be opposite to each other and are connected continuously, and the continuous ring-shaped magnetic steels 4, 4′ having the same pole and the magnetic collection ring 3 are arranged alternately.

2. The magnetizing device of new structure according to claim 1, wherein both thickness and diameter of the magnetic collection ring 3 are greater than that of the magnetic steel 4.

3. The magnetizing device of new structure according to claim 1, wherein longitudinal grooves are opened in the external and the internal baffles of diamagnetic material to allow liquid to flow therethrough; the external and internal baffles of diamagnetic material on adjacent layers being arranged in certain angles circumferentially to form a baffling device of diamagnetic material.
